(19) United States
(12) Patent Application Publication
(10) Pub. No.: US 2026/0286229 A1
(43) Pub. Date: Sep. 24, 2026

(54) DEVICE AND METHOD FOR INTEGRATED PRODUCTION OF AVIATION FUEL AND POROUS CARBON BY BIOMASS PYROLYSIS WITH GRADED CATALYTIC ACTIVATION

(71) Applicant: SOUTHEAST UNIVERSITY, Nanjing (CN)

(72) Inventors: Huiyan ZHANG, Nanjing (CN); Jiajun YU, Nanjing (CN); Rui XIAO, Nanjing (CN); Sheng CHU, Nanjing (CN); Yujie TAO, Nanjing (CN)

(73) Assignee: SOUTHEAST UNIVERSITY, Nanjing (CN)

(21) Appl. No.: 19/660,291

(22) Filed: Apr. 28, 2026

Related U.S. Application Data
(63) Continuation of application No. PCT/CN2025/087225, filed on Apr. 3, 2025.

(30) Foreign Application Priority Data
Mar. 19, 2025 (CN) 202510326593.9

(51) Int. Cl. C10G 1/02; B01J 8/00; B01J 8/02; B01J 8/08; B01J 8/26; C01B 3/36; C01B 32/312

(52) U.S. Cl. CPC C10G 1/02; B01J 8/0055; B01J 8/0278; B01J 8/087; B01J 8/26; C01B 3/36; C01B 32/312; C01B 2203/0227; C01B 2203/0255; C10G 2300/1011; C10G 2400/08

(57) ABSTRACT

A device and method for integrated production of an aviation fuel and a porous carbon by biomass pyrolysis with graded catalytic activation are provided. The device includes a catalytic pyrolysis bond-cleaving unit, a pyrolysis gas reforming unit, and an oxygen-rich carbon material activating unit. With the coupling of the three units, the biomass is firstly subjected to pyrolysis, catalytic bond cleavage and preliminary deoxygenation to enable the highly active oxygen-containing macromolecules to be enriched into a micromolecular thermally-stable intermediate matching the pores of the reforming catalyst, and then the intermediate is prepared into an aviation fuel precursor by catalytic reforming; the non-condensable gas generated in the pyrolysis and reforming process is used to activate the biochar to prepare an oxygen-rich porous carbon material and generate a hydrogen-rich gas, so that the hydrogen-rich gas enters the catalytic pyrolysis fluidized bed for participation in bond cleavage and deoxygenation.

### CROSS REFERENCE TO THE RELATED APPLICATIONS

This application is a continuation application of International Application No. PCT/CN2025/087225, filed on Apr. 3, 2025, which is based upon and claims priority to Chinese Patent Application No. 202510326593.9, filed on Mar. 19, 2025, the entire contents of which are incorporated herein by reference.

### TECHNICAL FIELD

The present disclosure relates to the field of comprehensive biomass utilization technologies and in particular to a device and method for integrated production of an aviation fuel and a porous carbon by biomass pyrolysis with graded catalytic activation.

### BACKGROUND

The current use of a huge quantity of fossil resources across the world has brought a series of issues related to energy and environment and it has been a research topic for various countries to develop a renewable clean energy to improve energy structure. Biomass is a low-sulfur, low-nitrogen and carbon-neutral renewable resource as well as a sole renewable organic carbon source in the nature. The biomass generated by photosynthesis each year around the world exceeds 170 billion tons, and the energy stored therein is equivalent to 10 to 20 times the total world energy consumption. Due to its rich resources and huge development potential, the biomass has become a natural excellent material to replace fossil resources such as coal, petroleum and natural gas and so on.

At present, the aromatic aviation fuel precursor is mainly produced by naphtha reforming and petroleum cracking, and a small part thereof is produced by coal coking. The carbon materials are mainly prepared with coal, petroleum and their derivatives as raw materials, and these traditional production lines have consumed massive fossil resources. Facing the huge challenges brought about by the shortage of petroleum resources and increasingly demanding CO ₂ emission standard, it has been a research hotspot to develop a preparation process for a clean and renewable aromatic hydrocarbon and carbon material. The biomass pyrolysis can convert biomass into gas, liquid and solid products under oxygen-free or oxygen-lean condition, featuring simple process, low requirement for equipment, and biomass full-component utilization and so on. The biomass catalytic pyrolysis is a technology for efficient preparation of aromatic hydrocarbon and carbon material, which can reduce the consumption of the fossil resources and CO₂ emission. However, there are still some problems to be solved in the biomass catalytic pyrolysis, for example, in the primary pyrolysis products, the highly reactive oxygen-containing macromolecules tend to polymerize and form coke, the pore structure of the carbon material is poor, the functional groups on the surface are less, and coupling is absent among the devices for biomass pyrolysis, catalytic conversion and carbon material activation and so on. In the prior arts, the patent with the publication number CN106811226B discloses a device and method for preparing high-quality liquid fuel by double-temperature-segment catalytic pyrolysis of biomass: the pyrolysis non-condensable gas of the device is directly used for catalytic pyrolysis and the reaction-generated coke is directly burnt out. The method, to some degree, mitigates the coking of the catalyst by combination of low-temperature pyrolysis torrefaction and high-temperature catalytic pyrolysis. But the by-products such as pyrolysis gas and pyrolysis carbon and so on are not fully utilized, and there is no beneficial connection between various flows of the pyrolysis process, and the overall economics of the device is to be improved. The patent with the publication number of CN104479720A discloses a method and device for preparing a high-yield hydrocarbon compound through binary catalytic pyrolysis of biomass. The invention uses a macro/mesoporous catalyst to cleave bonds and then uses a microporous catalyst to perform shape selection, while using the non-condensable gas as a carrier gas. In this method, the yield of the aromatic hydrocarbon is, to some extent, increased by binary catalysis. But the problems of mismatching of the commercial bond-cleaving catalysts with the pores of the microporous shape-selective catalysts, and the high oxygen content of the pyrolysis gas and so on limit the quality improvement of the bio-oil. Nowadays, the critical problem of preparing the renewable aviation fuel precursor and the carbon material by catalytic pyrolysis of biomass lies in that the effective hydrogen-carbon ratio of the biomass feedstock is low, the highly reactive oxygen-containing macromolecules containing a large number of oxygen-containing functional groups with relatively high reactivity in the primary pyrolysis products suffer severe high-temperature polycondensation; the pyrolysis macromolecules do not match the pores of the catalysts, and the highly reactive oxygen-containing macromolecules quickly form coke on the surfaces of the catalysts during carbon hydrocarbon preparation; the carbon material needs to form pores under high temperature, with the result of removing the functional groups on the surfaces. The above problems leads to a low target product yield of the catalytic pyrolysis process of biomass, and a low added value of the products, resulting in difficulty in large-scale application and promotion.

In view of the above, it is necessary to design a device and method for integrated production of an aviation fuel and a porous carbon by biomass pyrolysis with graded catalytic activation so as to solve the above problems.

### SUMMARY

The object of the present disclosure is to provide a device and method for integrated production of an aviation fuel and a porous carbon by biomass pyrolysis with graded catalytic activation, by which the biomass pyrolysis products are graded for conversion and utilized in different stages to prepare an aviation fuel precursor and a high-value porous carbon by efficient conversion of biomass while the problems of the hydrogen-deficient polycondensation of the traditional primary pyrolysis products, the quick coking of reforming catalyst and poor pores of the carbon material and so on can be solved.

In order to achieve the object of the present disclosure, the present disclosure provides a device for integrated production of an aviation fuel and a porous carbon by biomass pyrolysis with graded catalytic activation, which includes the following:

a catalytic pyrolysis bond-cleaving unit, including a catalytic pyrolysis fluidized bed, a separation mechanism and a bond-cleaving catalyst regeneration reactor connected in a circulation, wherein a bond-cleaving catalyst is regenerated and recycled for use in catalytic bond cleavage and preliminary deoxygenation of biomass; the catalytic pyrolysis fluidized bed is further connected with a biomass transport mechanism, and the bond-cleaving catalyst regeneration reactor is connected with the biomass transport mechanism to dry the biomass using a combustion smoke generated in regeneration of the bond-cleaving catalyst; the separation mechanism is further provided with a gas outlet and a biochar outlet;

a pyrolysis gas reforming unit, including a catalytic reforming reactor connected with the gas outlet, a condenser connected with a reformed gas outlet of the catalytic reforming reactor, and an aviation fuel precursor collector connected with the condenser;

an oxygen-rich carbon material activating unit, including a plasma activation reactor connected with the biochar outlet and the condenser and used to activate a biochar using a mixed gas and a non-condensable gas output by the condenser; the plasma activation reactor is further connected with a carbon material storage tank via a separator, and a gas treatment and transport mechanism for purifying a hydrogen-rich gas generated by the plasma activation reactor and then transporting a purified gas to the catalytic pyrolysis fluidized bed.

As a further improvement of the present disclosure, the separation mechanism includes a first cyclone separator connected with the catalytic pyrolysis fluidized bed and a vibration separator connected with the first cyclone separator.

As a further improvement of the present disclosure, the catalytic reforming reactor is connected with the first cyclone separator.

As a further improvement of the present disclosure, the catalytic reforming reactor includes a shell and a partition plate partitioning an interior of the shell into a reforming catalyst regeneration zone and a gas reforming zone for performing catalytic reforming through a reforming catalyst on a gas supplied by the separation mechanism; the reforming catalyst regeneration zone is connected with the gas reforming zone via a second cyclone separator to realize regeneration and recycling of the reforming catalyst and supply energy to the gas reforming zone using a combustion smoke generated in the regeneration of the reforming catalyst.

As a further improvement of the present disclosure, the gas reforming zone is connected with the condenser and the reforming catalyst regeneration zone via a third cyclone separator respectively, so that a reformed gas generated by catalytic reforming in the gas reforming zone enters the condenser, and at the same time, a deactivated reforming catalyst output by the gas reforming zone returns to the reforming catalyst regeneration zone for regeneration and recycling.

The present disclosure provides a method for integrated production of an aviation fuel and a porous carbon by biomass pyrolysis with graded catalytic activation based on the device according to claim 1, wherein the method includes the following steps:

S1, biomass is transported through the biomass transport mechanism to the catalytic pyrolysis fluidized bed for catalytic pyrolysis to generate a biochar, a first non-condensable gas, and a micromolecular thermally-stable intermediate; the bond-cleaving catalyst used in the catalytic pyrolysis fluidized bed is a metal-acid bifunctional catalyst capable of performing catalytic bond cleavage and preliminary deoxygenation on highly reactive oxygen-containing macromolecules in primary pyrolysis products generated in the biomass pyrolysis to form the micromolecular thermally-stable intermediate and activating alkane, olefin, hydrogen, and hydrogen-rich gas to generate a reactive hydrogen;

S2, the biochar, the first non-condensable gas and the micromolecular thermally-stable intermediate obtained in the step S1 are separated by the separation mechanism so that the first non-condensable gas and the micromolecular thermally-stable intermediate enter the catalytic reforming reactor for catalytic reforming, an aviation fuel precursor obtained by the condenser through condensation is collected into the aviation fuel collector, and a second non-condensable gas is transported to the plasma activation reactor;

the biochar enters the plasma activation reactor and is activated by a plasma generated through activation by a mixed gas and the second non-condensable gas in the plasma activation reactor to generate an oxygen-rich porous carbon material and a hydrogen-rich gas; the oxygen-rich porous carbon material is separated by the separator and then collected into the carbon material storage tank, and the hydrogen-rich gas is separated by the separator and purified by the gas treatment and transport mechanism and then transported to the catalytic pyrolysis fluidized bed for catalytic bond cleavage and preliminary deoxygenation of the highly reactive oxygen-containing macromolecules.

As a further improvement of the present disclosure, biomass includes agricultural waste, forestry waste, or microbial residues.

As a further improvement of the present disclosure, the particle size of the biomass is 10 to 20 meshes.

As a further improvement of the present disclosure, the temperature of the catalytic pyrolysis is 500 to 700℃; the reaction time of a gas generated by pyrolysis in a catalytic pyrolysis fluidized bed is 30 to 60s.

As a further improvement of the present disclosure, in a catalytic pyrolysis process, a deactivated bond-cleaving catalyst is regenerated in a bond-cleaving catalyst regeneration reactor to be recycled for the catalytic pyrolysis process of the catalytic pyrolysis fluidized bed, and the combustion smoke generated in the regeneration process of the bond-cleaving catalyst is used for biomass drying.

As a further improvement of the present disclosure, the temperature of the biomass subjected to drying treatment is 120 to 180℃.

As a further improvement of the present disclosure, the metal-acid bifunctional catalyst is a catalyst formed by loading active metals onto a multi-level mesoporous support rich in weak acid sites; the multi-level mesoporous support rich in weak acid sites includes any one of γ-Al₂O₃, Nb₂O₅ and Al₂O₃-SiO₂; the active metals include Ni, Ga and Ce; a reforming catalyst in the catalytic reforming reactor is a composite micro-mesoporous molecular sieve catalyst including any one of HZSM-5, Hβ, and HUSY.

As a further improvement of the present disclosure, in the step S2, the mixed gas includes nitrogen, argon, helium and water steam, wherein a weight ratio of the water steam to the biochar is (2 to 8):1; a low ratio of the water steam to the biochar may affect the activation effect of the biochar; and a too high ratio of the water steam to the biochar may affect the progress of the activation reaction due to large activation difficulty of the water steam.

As a further improvement of the present disclosure, the first non-condensable gas has the same components as the second non-condensable gas and includes carbon monoxide, carbon dioxide, alkane, olefin, water steam and hydrogen; the first non-condensable gas and the second non-condensable gas differs only in the content of each substance.

As a further improvement of the present disclosure, the highly reactive oxygen-containing macromolecules are an oxygen-containing macromolecular substance containing oxygen-containing functional groups with relatively high reactivity; the micromolecular thermally-stable intermediate is a micromolecular compound with good thermal stability, which is formed by performing preliminary bond cleavage on the highly reactive oxygen-containing macromolecules and removing some oxygen-containing functional groups.

As a further improvement of the present disclosure, the temperature of the catalytic reforming is 450 to 550° C.; the reaction time of the first non-condensable gas and the micromolecular thermally-stable intermediate in the catalytic reforming reactor is 20 to 40s.

As a further improvement of the present disclosure, the reaction time of the biochar in a plasma activation reactor is 10 to 20s.

As a further improvement of the present disclosure, the particle sizes of the bond-cleaving catalyst and the reforming catalyst both are 40 to 80 meshes.

The present disclosure has the following beneficial effects:
1. In the present disclosure, in the catalytic pyrolysis bond-cleaving unit, the biomass is pyrolyzed and the pyrolysis gases (the first non-condensable gas and the highly reactive oxygen-containing macromolecules in the primary pyrolysis products) are reacted with the metal-acid bifunctional catalyst simultaneously so that the highly reactive oxygen-containing macromolecules containing oxygen-containing functional groups with relatively high reactivity such as carbonyl, carboxyl and methoxyl in the pyrolysis gases are subjected to bond cleavage and preliminary deoxygenation and converted into the micromoelcular thermally-stable intermediate matching the pores of the reforming catalyst. In this way, the problem that the highly reactive oxygen-containing macromolecules is quickly coked on the surfaces of the catalysts during aromatic hydrocarbon preparation due to mismatch of the primary pyrolysis products with the pores of the reforming catalyst in the subsequent reforming process can be avoided, and so a liquid product with the aromatic aviation fuel precursor as main is obtained, effectively improving the quality of the aromatic aviation fuel.
2. In the present disclosure, the biochar is activated by activating the plasma using the water steam in combination with the second non-condensable gas so that the oxygen-containing plasma generated by ionization introduces the oxygen-containing functional groups while forming pores in the biochar. The finally-obtained oxygen-rich porous carbon material has a large specific surface, a good pore structure and rich surface functional groups. The plasma activation reactor is connected with the catalytic pyrolysis fluidized bed through a gas treatment and transport mechanism to enable a hydrogen-rich gas generated in the process of activating the biochar with the second non-condensable gas and the water steam to be recycled for catalytic bond cleavage and preliminary deoxygenation in the biomass pyrolysis and further enable the metal-acid bifunctional catalyst to, in addition to performing bond cleavage on the highly reactive oxygen-containing macromolecules to form a micromoelcular thermally-stable intermediate, activate alkane, olefin, hydrogen and hydrogen-rich gas in the pyrolysis gas to generate reactive hydrogen. The oxygen-containing functional groups in the highly reactive oxygen-containing macromolecules are combined with the reactive hydrogen, which noticeably inhibits the polymerization of the highly reactive oxygen-containing macromolecules, thereby solving the problems of the low effective hydrogen-carbon ratio of the biomass in the traditional pyrolysis process and severe high-temperature polycondensatoin of the primary pyrolysis products.
3. In the present disclosure, the catalytic pyrolysis bond-cleaving unit, the pyrolysis gas reforming unit and the oxygen-rich carbon material activating unit are coupled, which solves the problems of hydrogen-deficient polycondensation, poor carbon material quality and quick coking of the reforming catalyst and so on in the traditional biomass pyrolysis, and obtains the high-yield aviation fuel precursor and the oxygen-rich porous carbon material while realizing effective utilization of by-products and improving the process economics.

### BRIEF DESCRIPTION OF THE DRAWINGS

FIG. 1 is a schematic diagram illustrating an entire structure of a device for integrated production of an aviation fuel and a porous carbon by biomass pyrolysis with graded catalytic activation in the present disclosure.

FIG. 2 is a structural schematic diagram illustrating a catalytic reforming reactor.

FIG. 3 is a structural schematic diagram illustrating a plasma activation reactor.

### NUMERALS OF THE DRAWINGS

11. biomass storage bin; 111. protective gas inlet; 112. gas outlet; 12. spiral feeder; 121. heating jacket; 21. catalytic pyrolysis fluidized bed; 211 air supply fan; 212. product outlet; 22. first cyclone separator; 23. vibration separator; 231. separation screen; 24. bond-cleaving catalyst regeneration reactor; 25. regenerated catalyst feeder; 30. catalytic reforming reactor; 31. gas reforming zone; 311. gas reforming bed; 312. gas distributor plate; 313. gas inlet; 314. regenerated, reforming and fresh catalyst inlet; 32. partition plate; 33. reforming catalyst regeneration zone; 331. catalyst regeneration bed; 332. air distributor plate; 333. air inlet; 334. deactivated reforming catalyst inlet; 335. regenerated reforming catalyst outlet; 34. second cyclone separator; 35. third cyclone separator; 41. condenser; 42. oil-water separator; 43. aviation fuel precursor collector; 51. third cyclone separator; 511. biochar inlet; 512. mixed gas inlet; 513. second non-condensable gas; 514. reactant outlet; 52. plasma generation zone; 53. water steam generator; 54. fourth cyclone separator; 55. carbon material storage tank; 61. carbon dioxide separation chamber; 62. inducted draft fan.

### DETAILED DESCRIPTION OF THE EMBODIMENTS

In order to make the objects, technical solutions and advantages of the present disclosure clearer, the present disclosure will be detailed below in combination with the drawings and specific examples.

Further, it should be noted that in order to avoid unnecessary details obscuring the present disclosure, only the structures and/or treatment steps related closely with the solutions of the present disclosure are shown in the drawings while other details not closely related with the present disclosure are omitted.

Furthermore, it is further noted that the terms “including”, “containing” or any variation thereof are intended to encompass non-exclusive inclusion, so that a process, method, article or device including a series of elements includes not only those elements but also other elements not listed explicitly or those elements inherent to such a process, method, article or device.

### Example 1

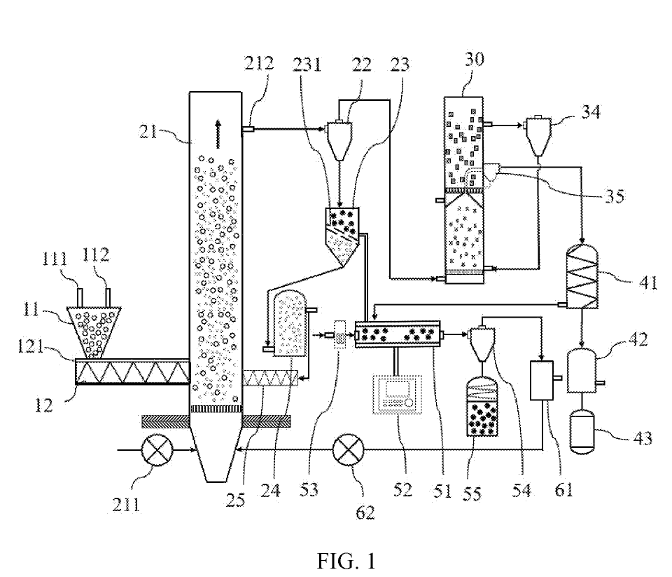

As shown in FIG. 1, the present disclosure provides a device for integrated production of an aviation fuel and a porous carbon by biomass pyrolysis with graded catalytic activation.

Specifically, a biomass transport mechanism includes a biomass storage bin 11 and a spiral feeder 12 connecting the biomass storage bin 11 with a catalytic pyrolysis fluidized bed 21. A feedstock inlet, a feedstock outlet, a protective gas inlet 111 and a gas outlet 112 are disposed on the biomass storage bin 11. After the biomass enters the biomass storage bin 11 through the feedstock inlet, an inert gas is input into the biomass storage bin 11 through the protective gas inlet to discharge air in the biomass storage bin 11 through the gas outlet 112, so as to fully remove the air in the biomass storage bin 11. An inlet of the spiral feeder 12 is connected with the feedstock outlet to transport the biomass in the biomass storage bin 11 into the catalytic pyrolysis fluidized bed 21.

A heating jacket 121 is further disposed on an outer wall of the spiral feeder 12.

Specifically, a nitrogen inlet and a hydrogen-rich gas inlet are disposed on a lower part of the catalytic pyrolysis fluidized bed 21. The nitrogen inlet is connected with an air supply fan 211 to supply nitrogen into the catalytic pyrolysis fluidized bed 21 and fluidize a first heat carrier of the catalytic pyrolysis fluidized bed 21 with the nitrogen; a product outlet 212 is disposed on an upper part of the catalytic pyrolysis fluidized bed 21. The catalytic pyrolysis fluidized bed 21 is used to make the biomass subjected to pyrolysis, catalytic bond cleavage and preliminary deoxygenation so that, under the action of the bond-cleaving catalyst, a part of oxygen in the highly reactive oxygen-containing macromolecules generated in the biomass pyrolysis is removed and the polymerization of the highly reactive oxygen-containing macromolecules is avoided. Further, the highly reactive oxygen-containing macromolecules are formed through catalytic bond cleavage into a micromolecular thermally-stable intermediate matching the pores of the reforming catalyst.

The bond-cleaving catalyst configured for the catalytic pyrolysis fluidized bed 21 is a metal-acid bifunctional catalyst formed by loading active metals onto a multi-level mesoporous support rich in weak acid sites. The multi-level mesoporous support rich in weak acid sites includes any one of γ-Al₂O₃, Nb₂O₅ and Al₂O₃-SiO₂, and the active metals include Ni, Ga and Ce so that, under the action of the active metals, alkane, olefin, hydrogen and hydrogen-rich gas are activated to generate reactive hydrogen. Under the action of the multi-level mesoporous support rich in weak acid sites, the highly reactive oxygen-containing macromolecules in the primary pyrolysis products are subjected to catalytic bond cleavage and preliminary deoxygenation to form a micromolecular thermally-stable intermediate.

Specifically, a separation mechanism includes a first cyclone separator 22 connected with the product outlet 212 of the catalytic pyrolysis fluidized bed 21 and a vibration separator 23 connected with the first cyclone separator 22. The vibration separator 23 includes a tank, a separation screen 231 and a screen tensioning device, where the separation screen 231 and the screen tensioning device are detachably disposed on the tank. The detachable disposal of the separation screen 231 facilitates timely change, and an acute angle of inclination of the separation screen 231 relative to a horizontal plane is 10 to 40°, and the separation screen 231 has a number of meshes of 20 to 40. The separation screen 231 divides the tank into an upper part and a lower part; a biochar outlet is disposed above the separation screen 231 corresponding to the upper part of the tank; and a deactivated catalyst outlet connected with a bond-cleaving catalyst regeneration reactor 24 is disposed on the lower part of the tank.

Specifically, provided on the bond-cleaving catalyst regeneration reactor 24 are an air inlet, a combustion smoke outlet connected with the heating jacket 121, a catalyst inlet connected with the deactivated catalyst outlet of the vibration separator 23, and a catalyst outlet connected to the catalytic pyrolysis fluidized bed 21 through a regenerated catalyst feeder 25, where the air inlet and the combustion smoke outlet are not shown herein. The combustion smoke outlet is connected with the heating jacket 121 to enable combustion smoke to flow in a direction contrary to that of the biomass, so as to dry the biomass using the combustion smoke, realizing effective energy utilization.

Specifically, the first cyclone separator 22 is further connected with a catalytic reforming reactor 30, namely, the air outlet of the separation mechanism is connected with the catalytic reforming reactor 30.

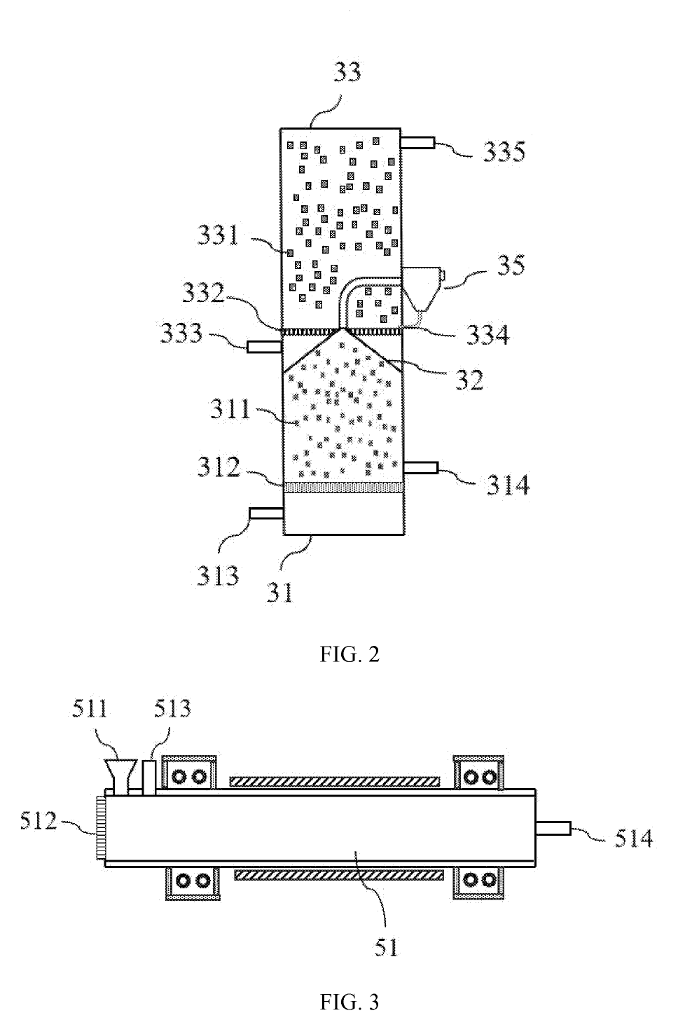

As shown in FIG. 2, the catalytic reforming reactor 30 includes a shell and a partition plate 32 partitioning the interior of the shell into a reforming catalyst regeneration zone 33 and a gas reforming zone 31 for performing catalytic reforming through the reforming catalyst on the gas supplied by the first cyclone separator 22 to generate an aviation fuel precursor; the reforming catalyst regeneration zone 33 is communicated with the gas reforming zone 31 through a second cyclone separator 34 to realize regeneration and recycling of the reforming catalyst and supply energy to the gas reforming zone 31 using the combustion smoke generated during the regeneration of the reforming catalyst, where the energy supply route for the combustion smoke of the reforming catalyst to supply energy to the gas reforming zone 31 is not shown herein. Illustratively, the partition plate 32 includes a plurality of tilted baffle plates so that a cone shape with a gradually-decreasing diameter is formed on an upper part of the gas reforming zone 31. A reformed gas outlet is disposed on the top of the cone shape, and the reformed gas outlet is respectively connected to a condenser 41 and a reforming catalyst regeneration zone 33 through a third cyclone separator 35.

The gas reforming zone 31 is further provided with a gas reforming bed 311, a gas distributor plate 312, a gas inlet 313, and a regenerated reforming and fresh catalyst inlet 314. The gas inlet 313 is connected with the first cyclone separator 22; the reforming catalyst regeneration zone 33 is provided with a catalyst regeneration bed 331, an air distributor plate 332, an air let 333, a deactivated reforming catalyst inlet 334 and a regenerated reforming catalyst outlet 335.

The second cyclone separator 34 is respectively connected with the regenerated reforming catalyst outlet 335 and the regenerated reforming and fresh catalyst inlet 314 to realize regeneration and recycling of the reforming catalyst.

The third cyclone separator 35, in addition to connecting with the condenser 41, also connects with the reformed gas outlet and the deactivated reforming catalyst inlet 334 respectively to separate the reformed gas generated in the gas reforming zone 31 from the solids such as the deactivated reforming catalyst, and transport the deactivated reforming catalyst to the reforming catalyst regeneration zone 33 for regeneration of the deactivated reforming catalyst and at the same time, transport the reformed gas to the condenser 41.

Specifically, an oil-water separator 42 is further disposed between the condenser 41 and an aviation fuel precursor collector 43.

Specifically, the plasma activation reactor includes an activation reaction zone 51 and a plasma generation zone 52. The activation reaction zone 51 is provided with a biochar inlet 511, a mixed gas inlet 512, a second non-condensable gas inlet 513 and a reactant outlet 514 (FIG. 3); the activation reaction zone 51 is used to activate a biochar into an oxygen-rich porous carbon material and generate a hydrogen-rich gas; the plasma generation zone 52 is used to adjust plasma activation reaction parameters and generate a plasma. For example, the mixed gas includes nitrogen, argon, helium, and water steam, where the water steam is generated by a water steam generator 53. For example, an end of the water steam generator 53 is connected with the mixed gas inlet 512 and the other end is connected with a gas inlet tube. Thus, the nitrogen, argon, helium enter the water steam generator 53 and then are formed into a mixed gas conveyed into the activation reaction zone 51; the separator is a fourth cyclone separator 54.

Specifically, the gas treatment and transport mechanism includes a carbon dioxide separation chamber 61 connected with the fourth cyclone separator 54 and an induced draft fan 62 connected with the carbon dioxide separation chamber 61. An outlet of the induced draft fan 62 is connected with the catalytic pyrolysis fluidized bed 21 to purify the hydrogen-rich gas generated in the plasma activation reactor and then transport the purified gas to the catalytic pyrolysis fluidized bed 21 for use in the catalytic bond cleavage and partial deoxygenation of the biomass.

Specifically, the working principle of the device for integrated production of the aviation fuel and the porous carbon by biomass pyrolysis with graded catalytic activation is as follows.

Catalytic bond cleavage in pyrolysis: the biomass in the biomass storage bin 11 is transported by the spiral feeder 12 to the catalytic pyrolysis fluidized bed 21 and pyrolyzed to generate primary pyrolysis products including the biochar, the first non-condensable gas and the highly reactive oxygen-containing macromolecules. The components of the first non-condensable gas are carbon monoxide, carbon dioxide, alkane, olefin, water steam and hydrogen; the alkane includes methane, ethane, propane and so on; the olefin includes ethylene and propylene and so on; the highly reactive oxygen-containing macromolecules are an oxygen-containing macromolecular substance containing oxygen-containing functional groups with relatively high reactivity such as carboxyl, carbonyl and methoxyl and so on. Furthermore, the bond-cleaving catalyst activates the alkane, olefin, hydrogen and hydrogen-rich gas (generated by the plasma activation reactor) to produce a reactive hydrogen which combines with the highly reactive oxygen-containing macromolecules in the primary pyrolysis products to remove some oxygen-containing functional groups with relatively high reactivity on the highly reactive oxygen-containing macromolecules and inhibit secondary polymerization of the highly reactive oxygen-containing macromolecules. Under the action of the bond-cleaving catalyst, the highly reactive oxygen-containing macromolecules are subjected to catalytic bond cleavage and preliminary deoxygenation to form a micromolecular thermally-stable intermediate matching the pores of the reforming catalyst, so as to avoid the subsequent problem of quick coking of the highly reactive oxygen-containing macromolecules on the surfaces of the catalyst at the time of preparation of aromatic hydrocarbon due to mismatch of the highly reactive oxygen-containing macromolecules with the pores of the reforming catalyst during the reforming process. Therefore, liquid products with the aromatic aviation fuel precursor as main are obtained subsequently, effectively improving the quality of the aromatic aviation fuel. The products generated in the catalytic pyrolysis fluidized bed 21 finally are the biochar, the first non-condensable gas and the micromolecular thermally-stable intermediate. The micromolecular thermally-stable intermediate is a micromolecular compound with good thermal stability formed by performing preliminary bond cleavage on the highly reactive oxygen-containing macromolecules and removing some oxygen-containing functional groups. With flowing of the products, the post-reaction deactivated bond-cleaving catalyst and the first heat carrier in the catalytic pyrolysis fluidized bed 21 are also output along with the products by the catalytic pyrolysis fluidized bed 21. The products output by the catalytic pyrolysis fluidized bed 21 are summarized as gas products (the first non-condensable gas and the micromolecular thermally-stable intermediate) and solid products (the biochar, the deactivated bond-cleaving catalyst and the first heat carrier).

Recycling of the deactivated bond-cleaving catalyst: the gas products and solid products generated in the catalytic pyrolysis fluidized bed 21 are separated by the first cyclone separator 22; the solid products, i.e. the biochar, the deactivated bond-cleaving catalyst and the first heat carrier are transported into the vibration separator 23 for further separation; through the further separation of the vibration separator 23, the biochar falls on the upper part of the tank and output by the biochar outlet to the plasma activation reactor, and the deactivated bond-cleaving catalyst and the heat carrier fall on the lower part of the tank and are output by the deactivated catalyst outlet to the bond-cleaving catalyst regeneration reactor 24 for regeneration of the deactivated bond-cleaving catalyst; afterwards, the bond-cleaving catalyst regenerated in the bond-cleaving catalyst regeneration reactor 24 and the first heat carrier are transported by the regenerated catalyst feeder 25 to the catalytic pyrolysis fluidized bed 21 so that the bond-cleaving catalyst can be regenerated and recycled for use in the catalytic bond cleavage and preliminary deoxygenation of the biomass. Further, heat is transferred by the first heat carrier and the combustion smoke generated in the regeneration of the deactivated bond-cleaving catalyst is transported to the heating jacket 121 on the outer wall of the spiral feeder 12 to dry the biomass, so as to realize full energy recovery and utilization.

Pyrolysis gas reforming: the gas products generated in the catalytic pyrolysis fluidized bed 21, i.e. the first non-condensable gas and the micromolecular thermally-stable intermediate flow through the gas inlet 313 of the gas reforming zone 31 into the gas reforming zone 31 and goes through catalytic reforming to generate a reformed gas; because the post-reaction deactivated reforming catalyst and the second heat carrier in the gas reforming bed 311 also flow out along with the reformed gas, the third cyclone separator 35 is used to separate the reformed gas, the deactivated reforming catalyst and the second heat carrier; the reformed gas flows to the condenser 41 and condensed to generate an aviation fuel precursor with a water content and the second non-condensable gas, and the aviation fuel precursor with a water content enters the oil-water separator 42 for separation to produce an aviation fuel precursor stored in the aviation fuel precursor collector 43, and the second non-condensable gas is transported to the activation reaction zone 51 of the plasma activation reactor; furthermore, the deactivated reforming catalyst and the second heat carrier flow through the deactivated reforming catalyst inlet 334 into the reforming catalyst regeneration zone 33 for regeneration, and the regenerated reforming catalyst, the second heat carrier and the combustion smoke generated in the regeneration process of the deactivated reforming catalyst flow to the second cyclone separator 34 for separation; the second heat carrier, together with the regenerated reforming catalyst, flows to the gas reforming zone 31 to realize recycling of the reforming catalyst while using the second heat carrier to transfer heat; the combustion smoke generated in the regeneration process of the deactivated reforming catalyst supplies energy to the gas reforming zone 31 and further the heat of the combustion smoke and the heat carrier is fully recovered for use in the reforming part of the pyrolysis gas.

Activation of the oxygen-rich carbon material: the mixed gas, the biochar and the second non-condensable gas flow through the mixed gas inlet 512, the biochar inlet 511 and the second non-condensable gas inlet 513 respectively into the activation reaction zone 51 of the plasma activation reactor and according to requirements, a plasma frequency and intensity is adjusted using the plasma generation zone 52, so that the water steam and the second non-condensable gas are activated to generate a plasma performing activation modification on the biochar so as to form pores in the biochar while introducing oxygen-containing functional groups, obtaining an oxygen-rich porous carbon material with a large specific surface, good pore structure and rich surface functional groups while producing a hydrogen-rich gas; the hydrogen-rich gas contains part of carbon dioxide; afterwards, under the separation effect of the fourth cyclone separator 54, the oxygen-rich porous carbon material flows into the carbon material storage tank 55 for storage, and the hydrogen-rich gas flows to the carbon dioxide separation chamber 61 for purification; then, the purified hydrogen-rich gas flows to the catalytic pyrolysis fluidized bed 21 through the induced draft fan 62 for catalytic bond cleavage and preliminary deoxygenation of the highly reactive oxygen-containing macromolecules in the primary pyrolysis products.

In the present disclosure, the catalytic pyrolysis bond-cleaving unit, the pyrolysis gas reforming unit and the oxygen-rich carbon material activating unit are coupled, so that the biomass is subjected to quick pyrolysis, in-situ catalysis and preliminary bond cleavage and enriched into a micromolecular thermally-stable intermediate matching the pores of the reforming catalyst; the micromolecular thermally-stable intermediate enters the pyrolysis gas reforming unit to prepare the aviation fuel precursor by catalytic upgrading; the bond-cleaving catalyst is regenerated and enters the catalytic pyrolysis fluidized bed 21 for recycling, and the combustion smoke generated in the regeneration of the bond-cleaving catalyst is used to dry the biomass; the second non-condensable gas generated in the catalytic reforming process enters the oxygen-rich carbon material activating unit to activate the biochar into an oxygen-rich porous carbon material while generating a hydrogen-rich gas which enters the catalytic pyrolysis fluidized bed 21 for participation in catalytic bond cleavage and preliminary deoxygenation; further, in the reforming part of the pyrolysis gas, two levels of cyclone separators (the second cyclone separator 34 and the third cyclone separator 35) are disposed to realize recycling of the reforming catalyst in cooperation with zoning of the catalytic reforming reactor 30; in addition, the combustion smoke generated in the regeneration of the reforming catalyst is used to supply energy to the gas reforming zone 31. The collaborative design of the above multiple units solves the problems of hydrogen-deficient polycondensation, poor carbon material quality and quick coking of the reforming catalyst and so on in the traditional biomass pyrolysis, and obtains the high-yield aviation fuel precursor and the oxygen-rich porous carbon material while realizing effective utilization of by-products generated in the device and improving the process economics.

The combustion smoke generated in the regeneration of the bond-cleaving catalyst and the reforming catalyst is used nearby for the biomass drying and supplying energy to the catalytic reforming reactor 30 respectively, and due to short heat transfer distance, better transfer and utilization effects are achieved, reducing the input of high-grade electric energy; further, the circulation arrangement of the first heat carrier and the second heat carrier can also transfer the heat and effectively improve the energy utilization rate.

### Example 2

The present disclosure provides a method for integrated production of an aviation fuel and a porous carbon by biomass pyrolysis with graded catalytic activation, which will be detailed below in combination with the above device for integrated production of the aviation fuel and the porous carbon by biomass pyrolysis with graded catalytic activation.

The specific steps are described below.

S1. 20-mesh rice straw is transported through the spiral feeder 12 to the catalytic pyrolysis fluidized bed 21 and quickly pyrolyzed at the temperature of 600℃ to produce the biochar, the first non-condensable gas and the highly reactive oxygen-containing macromolecules; further, under the action of the catalyst with a particle size of 60 meshes NiGaCe/Nb₂O₅, alkane, olefin, and hydrogen in the first non-condensable gas and hydrogen-rich gas transported by the gas treatment and transport mechanism are activated to generate a reactive hydrogen which combines with the highly reactive oxygen-containing macromolecules to remove some oxygen-containing functional groups with relatively high reactivity on the highly reactive oxygen-containing macromolecules and inhibit secondary polymerization of the highly reactive oxygen-containing macromolecules. In other words, under the action of the catalyst NiGaCe/Nb₂O₅, the highly reactive oxygen-containing macromolecules are subjected to catalytic bond cleavage and preliminary deoxygenation to form a micromolecular thermally-stable intermediate matching the pores of the reforming catalyst, namely, the biomass goes through catalytic bond cleavage in pyrolysis to generate the biochar, the first non-condensable gas and the micromolecular thermally-stable intermediate.

S2. The biochar, the first non-condensable gas and the micromolecular thermally-stable intermediate obtained in the step S1 are separated by a separation mechanism so that the first non-condensable gas and the micromolecular thermally-stable intermediate enter the gas reforming zone 31 of the catalytic reforming reactor 30, and are reformed to produce a reformed gas under the temperature of 500℃ and the catalytic effect of the catalyst HZSM-5; the reformed gas is condensed to produce an aviation fuel precursor with a water content and a second non-condensable gas; the aviation fuel precursor with a water content goes through oil-water separation to produce an aviation fuel precursor stored in the aviation fuel precursor collector 43, and the second non-condensable gas flows to the plasma activation reactor.

The biochar flows to the plasma activation reactor and is activated by the plasma generated through activation by the mixed gas and the second non-condensable gas in the plasma activation reactor to generate an oxygen-rich porous carbon material and a hydrogen-rich gas with a carbon dioxide content. The oxygen-rich porous carbon material is separated by the fourth cyclone separator 54 and then collected in the carbon material storage tank 55; the hydrogen-rich gas is separated by the fourth cyclone separator 54 and purified by the gas treatment and transport mechanism and then transported to the catalytic pyrolysis fluidized bed 21 for use in the catalytic bond cleavage of the pyrolysis gas; the reaction time of the biochar in the plasma activation reactor is 12s, and the weight ratio of the water steam to the pyrolysis carbon is 4:1.

Specifically, the deactivated bond-cleaving catalyst in the catalytic pyrolysis process is regenerated in the bond-cleaving catalyst regeneration reactor 24 to be recycled for the catalytic pyrolysis process of the catalytic pyrolysis fluidized bed 21; and the combustion smoke generated in the regeneration of the bond-cleaving catalyst is used for biomass drying, and the temperature of the biomass dried by the combustion smoke is 150℃.

Specifically, the deactivated reforming catalyst generated in the catalytic reforming process is regenerated in the reforming catalyst regeneration zone 33 of the catalytic reforming reactor 30 to be recycled for the catalytic reforming of the micromolecular thermally-stable intermediate; and the combustion smoke generated in the regeneration of the reforming catalyst supplies energy to the gas reforming zone 31 to realize full energy utilization.

The yield of the aviation fuel precursor in the example 2 is 8.71wt%, and the O element content of the carbon material is 23.88%; and the proportions of the carbonyl, carboxyl and ester functional groups on the surface of the carbon material are noticeably increased, improving the adsorption of the biochar to the pollutants.

### Examples 3 to 4

The examples 3 and 4 provide a method for integrated production of an aviation fuel and a porous carbon by biomass pyrolysis with graded catalytic activation. Compared with the example 2, the weight ratio of the water steam to the pyrolysis carbon is adjusted from 4:1 to 2:1 and 8:1 respectively in the examples 3 and 4. Other steps are consistent with the example 2 and no redundant descriptions are made herein.

The yield of the aviation fuel precursor in the example 3 is 7.83 wt% and the O element content of the carbon material is 21.35%; the yield of the aviation fuel precursor in the example 4 is 7.34wt% and the O element content of the carbon material is 22.72%.

### Control example 1

The control example 1 provides a method for integrated production of an aviation fuel and a porous carbon by biomass pyrolysis with graded catalytic activation. Compared with the example 2, the biochar obtained in the step S1 in the control example 1 no longer flows into the plasma activation reactor but directly flows into the carbon material storage tank 55; the second non-condensable gas directly flows to the catalytic pyrolysis fluidized bed. Other steps are consistent with the example 2 and no redundant descriptions are made herein.

The yield of the aviation fuel precursor in the control example 1 is 6.42 wt% and the O element content of the carbon material is 20.15%.

By product comparison of the example 2, the example 3, the example 4 and the control example 1, it can be known that the aviation fuel precursor obtained by the method for integrated production of the aviation fuel and the porous carbon by biomass pyrolysis with graded catalytic activation in the present disclosure has a high yield and the O element content of the carbon material is high.

The above examples are used only for illustrating the technical solutions of the present disclosure rather than for limiting the present disclosure.

What is claimed is:

1. A device for integrated production of an aviation fuel and a porous carbon by biomass pyrolysis with graded catalytic activation, comprising:
a catalytic pyrolysis bond-cleaving unit, comprising a catalytic pyrolysis fluidized bed, a separation mechanism, and a bond-cleaving catalyst regeneration reactor connected in a circulation, wherein a bond-cleaving catalyst is regenerated and recycled for use in catalytic bond cleavage and preliminary deoxygenation of biomass; the catalytic pyrolysis fluidized bed is further connected with a biomass transport mechanism, and the bond-cleaving catalyst regeneration reactor is connected with the biomass transport mechanism to dry the biomass using a combustion smoke generated in regeneration of the bond-cleaving catalyst; the separation mechanism is further provided with a gas outlet and a biochar outlet;
a pyrolysis gas reforming unit, comprising a catalytic reforming reactor connected with the gas outlet, a condenser connected with a reformed gas outlet of the catalytic reforming reactor, and an aviation fuel precursor collector connected with the condenser;
an oxygen-rich carbon material activating unit, comprising a plasma activation reactor connected with the biochar outlet and the condenser and used to activate a biochar using a mixed gas and a non-condensable gas output by the condenser; the plasma activation reactor is further connected with a carbon material storage tank via a separator, and a gas treatment and transport mechanism for purifying a hydrogen-rich gas generated by the plasma activation reactor and then transporting a purified gas to the catalytic pyrolysis fluidized bed.

2. The device for integrated production of the aviation fuel and the porous carbon by biomass pyrolysis with graded catalytic activation according to claim 1, wherein the separation mechanism comprises a first cyclone separator connected with the catalytic pyrolysis fluidized bed and a vibration separator connected with the first cyclone separator.

3. The device for integrated production of the aviation fuel and the porous carbon by biomass pyrolysis with graded catalytic activation according to claim 2, wherein the catalytic reforming reactor is connected with the first cyclone separator.

4. The device for integrated production of the aviation fuel and the porous carbon by biomass pyrolysis with graded catalytic activation according to claim 1, wherein the catalytic reforming reactor comprises a shell and a partition plate partitioning an interior of the shell into a reforming catalyst regeneration zone and a gas reforming zone for performing catalytic reforming through a reforming catalyst on a gas supplied by the separation mechanism; the reforming catalyst regeneration zone is connected with the gas reforming zone via a second cyclone separator to realize regeneration and recycling of the reforming catalyst and supply energy to the gas reforming zone using a combustion smoke generated in regeneration of the reforming catalyst.

5. The device for integrated production of the aviation fuel and the porous carbon by biomass pyrolysis with graded catalytic activation according to claim 4, wherein the gas reforming zone is connected with the condenser and the reforming catalyst regeneration zone via a third cyclone separator respectively, so that a reformed gas generated by catalytic reforming in the gas reforming zone enters the condenser, and at the same time, a deactivated reforming catalyst output by the gas reforming zone returns to the reforming catalyst regeneration zone for regeneration and recycling.

6. A method for integrated production of an aviation fuel and a porous carbon by biomass pyrolysis with graded catalytic activation based on the device according to claim 1, wherein the method comprises the following steps:
S1, biomass is transported through the biomass transport mechanism to the catalytic pyrolysis fluidized bed for catalytic pyrolysis to generate a biochar, a first non-condensable gas, and a micromolecular thermally-stable intermediate; the bond-cleaving catalyst used in the catalytic pyrolysis fluidized bed is a metal-acid bifunctional catalyst capable of performing catalytic bond cleavage and preliminary deoxygenation on highly reactive oxygen-containing macromolecules in primary pyrolysis products generated in the biomass pyrolysis to form the micromolecular thermally-stable intermediate and activating alkane, olefin, hydrogen, and hydrogen-rich gas to generate a reactive hydrogen;
S2, the biochar, the first non-condensable gas, and the micromolecular thermally-stable intermediate obtained in the step S1 are separated by the separation mechanism so that the first non-condensable gas and the micromolecular thermally-stable intermediate enter the catalytic reforming reactor for catalytic reforming, an aviation fuel precursor obtained by the condenser through condensation is collected into the aviation fuel collector, and a second non-condensable gas is transported to the plasma activation reactor;
the biochar enters the plasma activation reactor and is activated by a plasma generated through activation by a mixed gas and the second non-condensable gas in the plasma activation reactor to generate an oxygen-rich porous carbon material and a hydrogen-rich gas; the oxygen-rich porous carbon material is separated by the separator and then collected into the carbon material storage tank, and the hydrogen-rich gas is separated by the separator and purified by the gas treatment and transport mechanism and then transported to the catalytic pyrolysis fluidized bed for catalytic bond cleavage and preliminary deoxygenation of the highly reactive oxygen-containing macromolecules.

7. The method for integrated production of the aviation fuel and the porous carbon by biomass pyrolysis with graded catalytic activation according to claim 6, wherein the metal-acid bifunctional catalyst is a catalyst formed by loading active metals onto a multi-level mesoporous support rich in weak acid sites; the multi-level mesoporous support rich in weak acid sites comprises any one of γ-Al₂O₃ Nb₂O₅and Al₂O₃-SiO₂; the active metals comprise Ni, Ga, and Ce.

8. The method for integrated production of the aviation fuel and the porous carbon by biomass pyrolysis with graded catalytic activation according to claim 6, wherein a reforming catalyst in the catalytic reforming reactor is a composite micro-mesoporous molecular sieve catalyst comprising any one of HZSM-5, Hβ, and HUSY.

9. The method for integrated production of the aviation fuel and the porous carbon by biomass pyrolysis with graded catalytic activation according to claim 6, wherein in the step S2, the mixed gas comprises nitrogen, argon, helium, and water steam, wherein a weight ratio of the water steam to the biochar is (2 to 8):1.

10. The method for integrated production of the aviation fuel and the porous carbon by biomass pyrolysis with graded catalytic activation according to claim 6, wherein the first non-condensable gas has the same components as the second non-condensable gas and comprises carbon monoxide, carbon dioxide, alkane, olefin, water steam, and hydrogen.
